(19) United States
(12) Patent Application Publication
(10) Pub. No.: US 2019/0224706 A1
(43) Pub. Date: Jul. 25, 2019

(54) DISPENSING PUMP

(71) Applicant: TSAI-HUI LIN, KAOHSIUNG CITY (TW)

(72) Inventor: TSAI-HUI LIN, KAOHSIUNG CITY (TW)

(21) Appl. No.: 16/178,797

(22) Filed: Nov. 2, 2018

(30) Foreign Application Priority Data
Jan. 22, 2018 (TW) 107201044

(51) Int. Cl. B05B 11/00

(52) U.S. Cl. CPC B05B 11/3047; B05B 11/0037; B05B 11/3073; B05B 11/307; B05B 11/0062; B05B 11/3069

(57) ABSTRACT

The present invention relates to a dispensing pump which mainly comprises a cap, a cylindrical pump body having a first elastic member therein, a ball valve fixed at a bottom of the cylindrical pump body, a needle valve fixed at a top end of the cylindrical pump body, and a pressing tube connected to an upper side of the needle valve and having a pressing head connected to an upper end thereof.

### BACKGROUND OF THE INVENTION

### 1. Field of the Invention

The present invention relates to dispensing pump which has a ball valve and a needle valve to keep a vacuum state of a cylindrical pump body during operation and avoids flushing up and leakage of excess fluid from an output so as to achieve effects of controlling fluid outflow amount precisely in use.

### 2. Description of Related Art

Different kinds of containers are used for storing fluids. For instance, liquid condiments for cooking, body cleaning products such as shower gel and shampoo, and liquid cosmetics are usually stored in various kinds of containers as bottles or cans. For using conveniently, a dispensing pump is installed in a container for pumping the fluid out of the container by pressing a pressing head of the dispensing pump.

A dispensing pump mainly comprises a cylindrical pump body, a pressing tube accommodated in the cylindrical pump body, a pressing head disposed on an upper end of the pressing tube, an elastic member sleeved on a lower region of the pressing tube in the cylindrical pump body, a guiding pipe connected to a bottom of the cylindrical pump body, and a ball valve disposed between the cylindrical pump body and the guiding pipe. When the pressing head is pressed, the pressing tube is driven to move into the cylindrical pump body and a fluid in the cylindrical body flows outward from an output of the pressing tube. When the pressing head is released, the elastic member rebounds to push the pressing tube and the pressing head back to an original position. At the same time, a negative pressure state is formed in the cylindrical pump body and a ball in the ball valve moves to open up the ball valve, so the fluid in the container is flowed through the guiding pipe into the cylindrical pump body for storing.

The dispensing pump mentioned above exports the fluid from the container by pressing the pressing head which is convenient in use. However, the dispensing pump only has a ball valve disposed between the cylindrical pump body and guiding pipe to control the fluid flowing into the cylindrical pump body, so a vacuum state in the cylindrical pump body is affected if the ball in the ball valve is shifted due to a shake during usage. Furthermore, the fluid in the container is easily flushed up and leaked out from the output when the pressing tube and the pressing head are pushed back to the original position by the elastic member. In such a case, a fluid outflow amount is not controlled accurately by the dispensing pump, which is very inconvenient for catering industry in which the fluid outflow amount of the liquid condiment must be controlled accurately, and needs to be improved.

### SUMMARY OF THE INVENTION

The present invention provides a dispensing pump having a ball valve and a needle valve connected to a bottom end and a top end of a cylindrical pump body respectively. The ball valve is used to control a fluid inflow to the cylindrical pump body from a container, and the needle valve is used to control a fluid outflow from the cylindrical pump body to an output. The ball valve and the needle valve maintain a vacuum state of the cylindrical pump body and avoid flushing up and leakage of excess fluid from an output so as to achieve effects of controlling a fluid outflow amount precisely in use.

The dispensing pump of the present invention mainly comprises a cap, a cylindrical pump body, a ball valve, a needle valve and a pressing tube.

The cap has an assembly hole.

The cylindrical pump body is inserted to the assembly hole of the cap by a top end thereof and has an upper supporting member, a lower supporting member and a first elastic member. The upper supporting member is disposed in an upper region of the cylindrical pump body, the lower supporting member is disposed in a lower region of the cylindrical pump body, and the first elastic member is disposed between the upper supporting member and the lower supporting member.

The ball valve has a ball valve seat having an inlet passage and a first guiding hole, a positioning element, a ball and a guiding pipe. The ball valve seat is connected to a bottom of the cylindrical pump body for contacting the lower supporting member. The inlet passage passes through the ball valve seat and communicated with the first guiding hole disposed at a bottom of the ball valve seat. The positioning element is inserted across the inlet passage. The ball is movably disposed below the positioning element in the inlet passage, and a shifting distance of the ball is limited by the positioning element. The guiding pipe is communicated with the first guiding hole at the bottom end of the ball valve seat.

The needle valve has a needle valve seat having an outlet passage and a second guiding hole, a positioning seat, a valve body and a second elastic member. The needle valve seat is disposed at the top end of the cylindrical pump body for contacting the upper supporting member. The outlet passage passes through the needle valve seat and communicated with the second guiding hole disposed at a bottom of the needle valve seat. The positioning seat is disposed at an upper side of the needle valve seat. The valve body is disposed in the outlet passage, and the second elastic member is disposed between the valve body and the positioning seat.

The pressing tube is connected to the upper side of the needle valve seat and communicated with the outlet passage. The pressing tube has an output at one side thereof and a pressing head at an upper end thereof.

According to an embodiment of the present invention, the positioning element of the ball valve is a pin.

According to an embodiment of the present invention, a positioning cap formed with a position hole thereon and is further provided between the pressing tube and the pressing head via the position hole for limiting a pressing distance of the pressing head.

### BRIEF DESCRIPTION OF THE DRAWINGS

FIG. 1 is an exploded diagram showing a first embodiment for a dispensing pump of the present invention;

FIG. 2 is a stereogram showing the first embodiment for the dispensing pump of the present invention in assembly;

FIG. 3 is a sectional view showing a dispensing pump of the present invention in assembly;

FIG. 4 is a sectional view showing a dispensing pump of the present invention in a pressed state;

FIG. 5 is a sectional view showing a dispensing pump of the present invention in a reset state;

FIG. 6 is an exploded diagram showing a second embodiment for a dispensing pump of the present invention;

FIG. 7 is a stereogram showing the second embodiment for the dispensing pump of the present invention in assembly.

### DETAILED DESCRIPTION OF THE PREFERRED EMBODIMENT

To provide a thorough understanding, the purpose and advantages of the present invention will be described in detail with reference to the accompanying drawings.

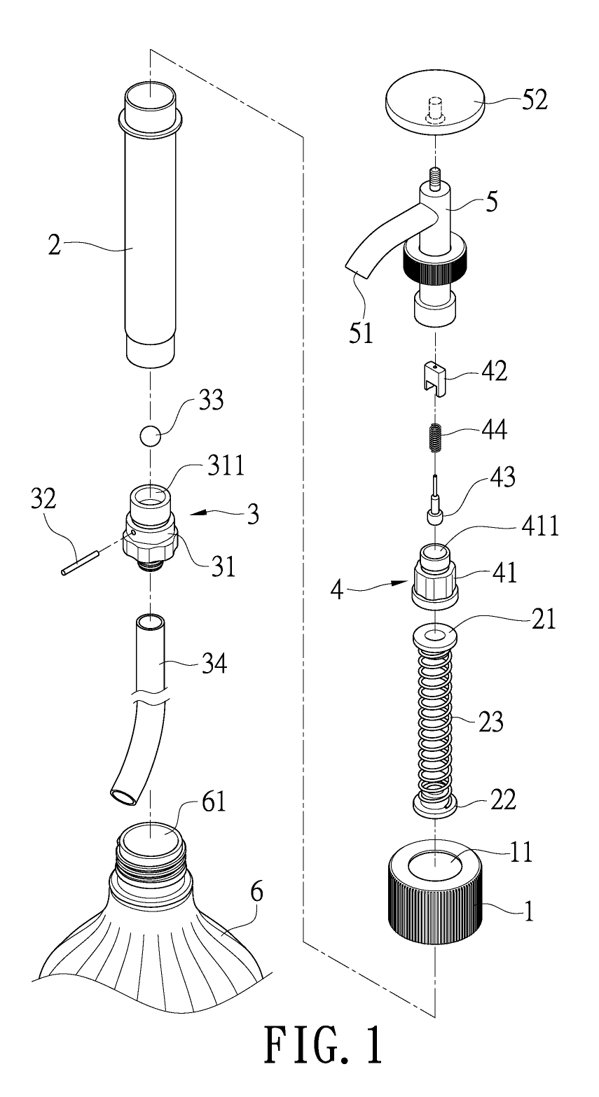

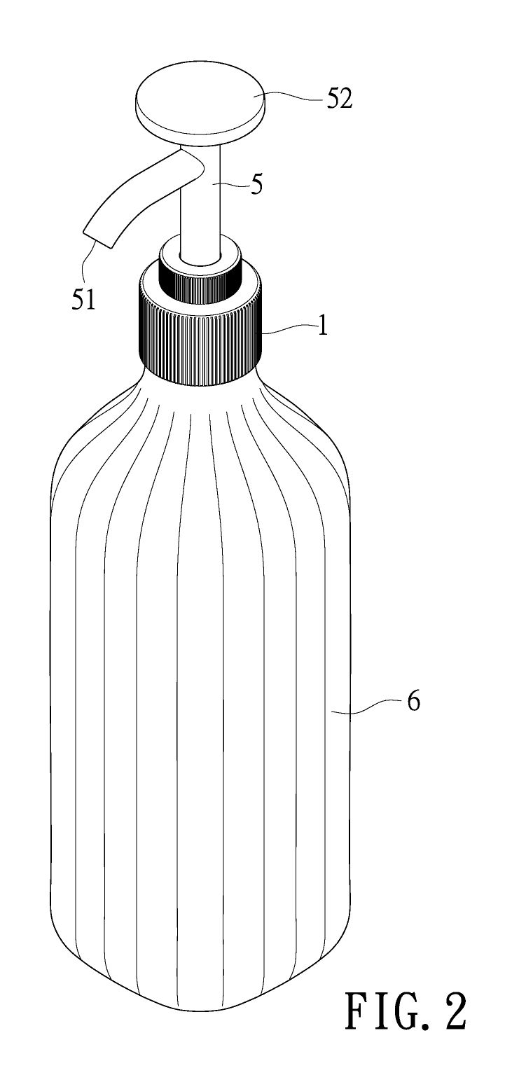

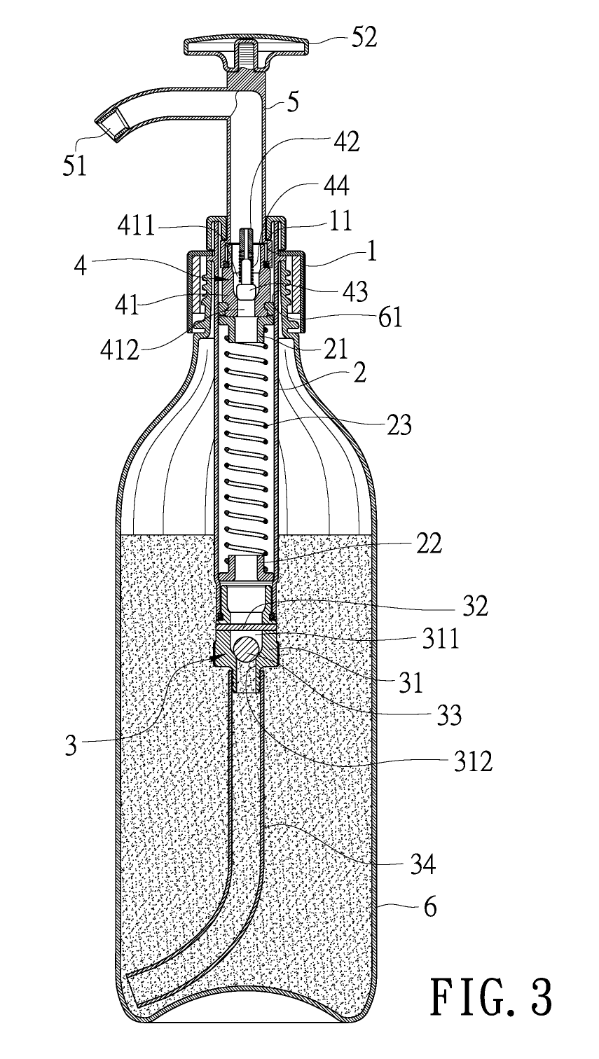

Referring to FIG. 1, FIG. 2 and FIG. 3 which are an exploded diagram, a stereogram and a sectional view of the present invention, the present invention comprises a cap (1), a cylindrical pump body (2), a ball valve (3), a needle valve (4), and a pressing tube (5).

The cap (1) has an assembly hole (11), and is assembled to an opening (61) of a container (6).

The cylindrical pump body (2) is inserted to the assembly hole (11) of the cap (1) by a top end, and has an upper supporting member (21), a lower supporting member (22) and a first elastic member (23). The upper supporting member (21) is disposed in an upper region of the cylindrical pump body (2), the lower supporting member (22) is disposed in a lower region of the cylindrical pump body (2), and the first elastic member (23) is disposed between the upper supporting member (21) and the lower supporting member (22).

The ball valve (3) has a ball valve seat (31) having an inlet passage (311) and a first guiding hole (312), a positioning element (32), a ball (33) and a guiding pipe (34). The ball valve seat (31) is connected to a bottom of the cylindrical pump body (2) for contacting the lower supporting member (22). The inlet passage (311) passes through the ball valve seat (31) and communicated with the first guiding hole (312) disposed at a bottom of the ball valve seat (31). The positioning element (32) is inserted across the inlet passage (311) and the positioning element (32) can be a pin. The ball (33) is movably disposed below the positioning element (32) in the inlet passage (311), and a shifting distance of the ball (33) is limited by the positioning element (32). The ball (33) can be moved up and down between the positioning element (32) and the first guiding hole (312), and is plugged in the first guiding hole (312) when moving downward. The guiding pipe (34) is communicated with the first guiding hole (312) at the bottom end of the ball valve seat (31).

The needle valve (4) has a needle valve seat (41) having an outlet passage (411) and a second guiding hole (412), a positioning seat (42), a valve body (43) and a second elastic member (44). The needle valve seat (41) is disposed at the top end of the cylindrical pump body (2) for contacting the upper supporting member (21). The outlet passage (411) passes through the needle valve seat (41) and communicated with the second guiding hole (412) disposed at a bottom of the needle valve seat (41). The positioning seat (42) is disposed at an upper side of the needle valve seat (41). The valve body (43) is disposed in the outlet passage (411), and the second elastic member (44) is disposed between the valve body (43) and the positioning seat (42) corresponding to a filled fluid with different thickness for driven the valve body (43) moving up and down between the positioning seat (42) and the second guiding hole (412). When the valve body (43) is pushed down by the second elastic member (44), the second guiding hole (412) is plugged by the valve body (43).

The pressing tube (5) is connected to the upper side of the needle valve seat (41) of the needle valve (4) and communicated with the outlet passage (411) of the needle valve seat (41). The pressing tube (5) has an output (51) at one side and a pressing head (52) at an upper end of the pressing tube (5).

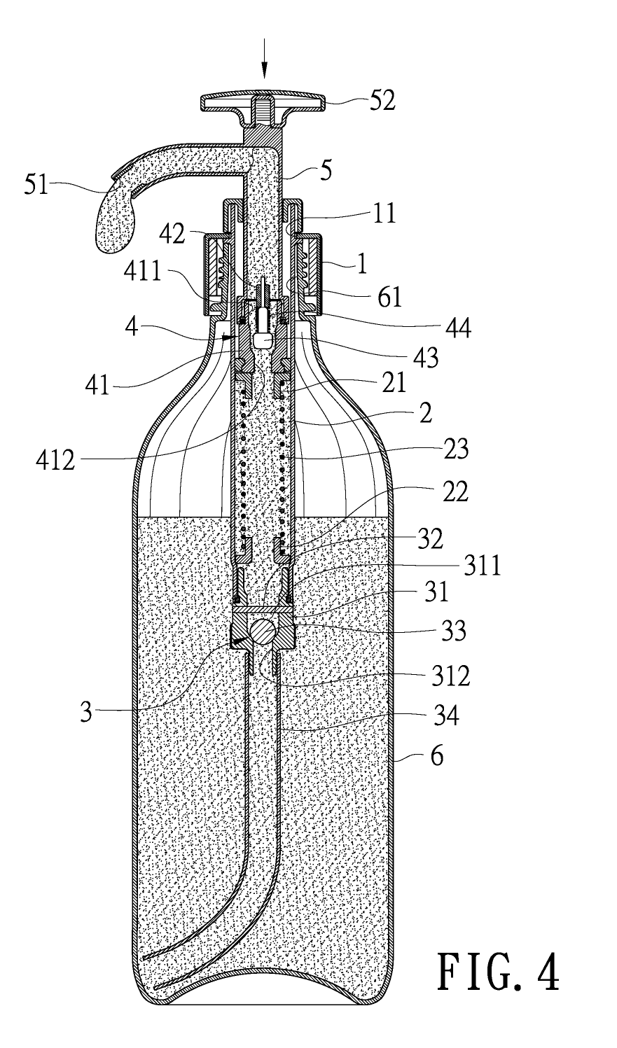

Please refer to FIG. 4, when pumping out a fluid from the container (6) by the present invention, the pressing head (52) at the upper end of the pressing tube (5) is pressed down to drive the pressing tube (5) moving into the cylindrical pump body (2), and drive the needle valve seat (41) and the upper supporting member (21) moving down for extruding the fluid in the cylindrical pump body (2). The ball (33) in the inlet passage (311) of the ball valve seat (31) is then pushed down by the extruded fluid for plugging in the first guiding hole (312). As the needle valve seat (41) is driven to move into the cylindrical pump body (2) by the pressing tube (5), the fluid in the cylindrical pump body (2) pushes the valve body (43) up by passing through the second guiding hole (412) of the needle valve seat (41), and then passes through the outlet passage (411) of the needle valve seat (41) for exporting from the output (51) of the pressing tube (5).

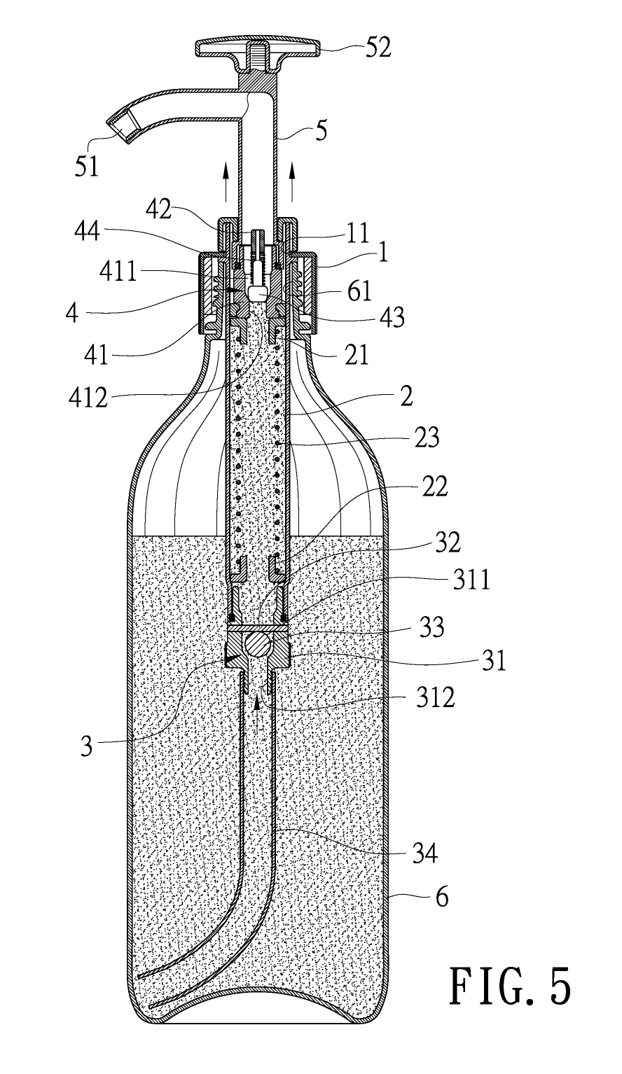

Referring to FIG. 5, when the pressing head (52) of the pressing tube (5) is released from a pressed state, the first elastic member (23) of the cylindrical pump body (2) is rebounded to push the upper supporting member (21), the needle valve seat (41) and the pressing tube (5) back to an original position. In the moving up process of the needle valve seat (41) and the pressing tube (5), a negative pressure state is formed in the cylindrical pump body (2) and the valve body (43) is pushed by the negative pressure state and a resilience of the second elastic member (44) disposed between the valve body (43) and the positioning seat (42) to plug in the second guiding hole (412), and then the ball (33) is drew away from the first guiding hole (312) in which a shifting distance of the ball (33) is limited by the positioning element (32). If the positioning element (32) is installed at a higher region of the ball valve (3), the shifting distance of the ball (33) is longer which can increase an inflow volume of the fluid imported from the first guiding hole (312). Accordingly, the fluid in the container (6) is flowed into the cylindrical pump body (2) by passing through the guiding pipe (34), the first guiding hole (312) and the inlet passage (311) for storing.

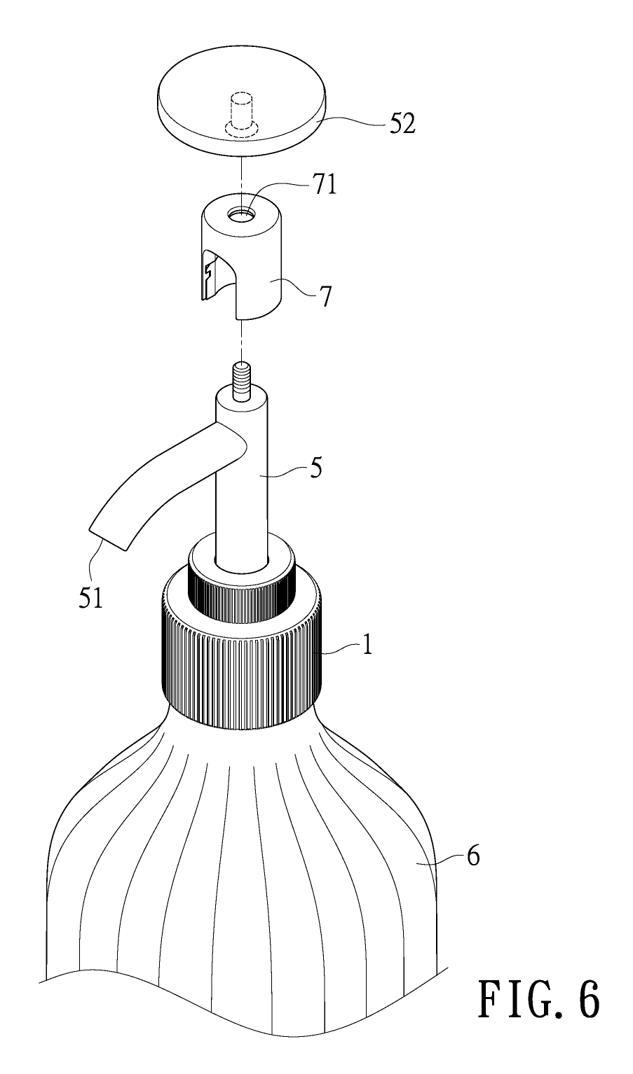

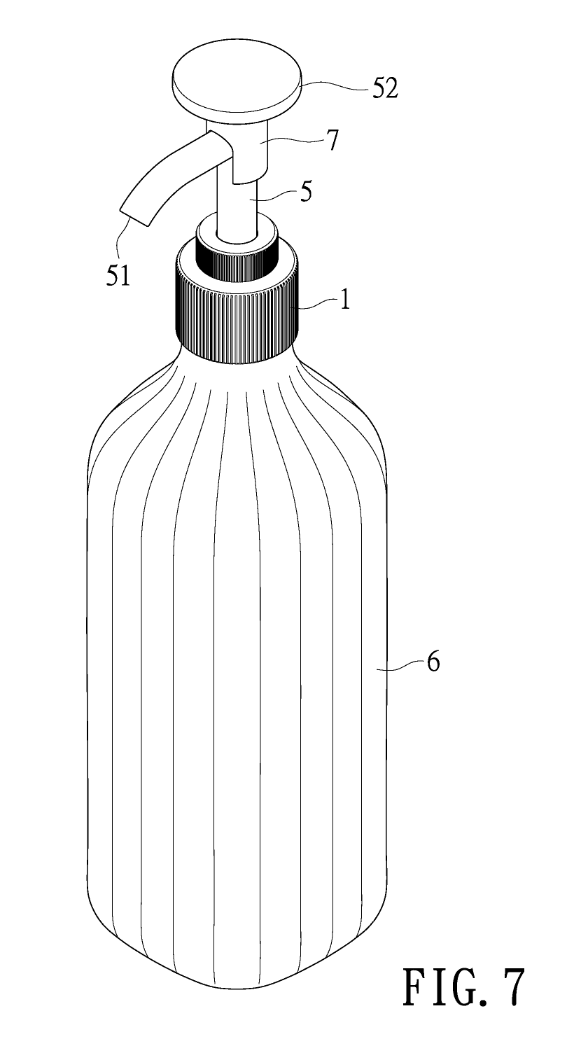

Referring to FIG. 6, a positioning cap (7) formed with a position hole (71) thereon is disposed between the pressing tube (5) and the pressing head (52) via the position hole (71) for regulating an outflow amount of the fluid from the output (51) of the pressing tube (5). Referring to FIG. 7, when the pressing head (52) is pressed down, a pushing distance of the pressing head (52) is limited by the positioning cap (7) so as to limit a moving distance of the pressing tube (5) inside the cylindrical pump body (2), and an effect of controlling an outflow amount of the fluid from the output (51) is achieved.

Accordingly, the present invention provides a dispensing pump having a ball valve and a needle valve connected to a bottom end and a top end of a cylindrical pump body respectively. The ball valve is used to control a fluid inflow to the cylindrical pump body from a container, and the needle valve is used to control a fluid outflow from the cylindrical pump body to the output. The ball valve and the needle valve maintain a vacuum state of the cylindrical pump body and avoid flushing up and leakage of excess fluid from the output so as to achieve effects of controlling a fluid outflow amount precisely in use.

What is claimed is:

1. An dispensing pump, comprising:
a cap having an assembly hole;
a cylindrical pump body inserted to the assembly hole of the cap by a top end thereof and having an upper supporting member in an upper region thereof, a lower supporting member in a lower region thereof, and a first elastic member disposed between the upper supporting member and the lower supporting member;
a ball valve having a ball valve seat connected to a bottom of the cylindrical pump body, a positioning element, a ball movably disposed below the positioning element, and a guiding pipe at a bottom of the ball valve seat; wherein the ball valve seat has an upper end for contacting the lower supporting member, an inlet passage for insertion of the positioning element, a first guiding hole disposed at a bottom of the inlet passage for communicating with the guiding pipe, and wherein the positioning element limits a shifting distance of the ball;
a needle valve having a needle valve seat disposed at the top end of the cylindrical pump body for contacting the upper supporting member by a bottom thereof, a positioning seat disposed at an upper side of the needle valve seat, a valve body, and a second elastic member between the valve body and the positioning seat, wherein the needle valve seat has an outlet passage for accommodating the valve body and a second guiding hole disposed at the bottom of the needle valve seat for communicating with the outlet passage; and
a pressing tube connected to the upper side of the needle valve seat for communicating with the outlet passage and having an output at one side thereof and a pressing head at an upper end thereof.

2. The dispensing pump as claimed in claim 1, wherein the positioning element of the ball valve is a pin.

3. The dispensing pump as claimed in claim 1, wherein a positioning cap formed with a positioning hole thereon is further disposed between the pressing tube and the pressing head for limiting a pressing distance of the pressing head.
